(19) United States
(12) Patent Application Publication
(10) Pub. No.: US 2026/0154388 A1
(43) Pub. Date: Jun. 4, 2026

(54) SYSTEM AND METHOD FOR DIGITAL AUTHENTICATION DURING A VOICE CALL

(71) Applicant: The Toronto-Dominion Bank, Toronto (CA)

(72) Inventors: Ajey Inder NATH, Toronto (CA); Ruchira GHOSH, Dallas, TX (US); Vivekanand KURDIKERI, London (CA)

(73) Assignee: The Toronto-Dominion Bank, Toronto, ON (CA)

(21) Appl. No.: 18/968,377

(22) Filed: Dec. 4, 2024

(51) Int. Cl. G06F 21/32

(52) U.S. Cl. CPC G06F 21/32

(57) ABSTRACT

A computer system comprises at least one processor; a communications module coupled to the at least one processor; and a memory coupled to the at least one processor, the memory storing instructions that, when executed, configure the at least one processor to initiate a voice call session with a client device; determine that the client device has a passkey installed thereon; send, via the communications module and to the client device, a request for authentication; receive, via the communications module and from the client device, a signal that includes a unique confirmation message; and analyze the unique confirmation to confirm authentication.

### TECHNICAL FIELD

The present application relates to systems and methods for digital authentication during a voice call.

### BACKGROUND

Knowledge-based authentication methods, such as security questions, are inherently vulnerable to a range of security risks. For example, these methods often rely on personal information, such as a pet's name, that is either publicly accessible or easily guessed, making them susceptible to data mining attacks. Further, answers to these questions are often static and unchanging which increases the likelihood of unauthorized access. Oftentimes, these methods fail to accommodate users who may forget or change their answers over time, leading to authentication failures and increased reliance on insecure recovery mechanisms such as email resets.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of an example computer device;

FIG. 3 is a high-level schematic diagram of an example computer system;

FIG. 4 shows a simplified organization of software components stored in a memory of the computer system of FIG. 3;

FIG. 5 shows, in flowchart form, an example method for storing a public key;

FIG. 6 shows, in flowchart form, an example method for digital authentication during a voice call;

FIG. 7 shows an example notification displayed within a notification center on a display screen of a client device; and

FIG. 8 shows another example notification displayed within a mobile application on a display screen of a client device.

Like reference numerals are used in the drawings to denote like elements and features.

### DETAILED DESCRIPTION OF VARIOUS EMBODIMENTS

Accordingly, in one aspect there is provided a computer system comprising at least one processor; a communications module coupled to the at least one processor; and a memory coupled to the at least one processor, the memory storing instructions that, when executed, configure the at least one processor to initiate a voice call session with a client device; determine that the client device has a passkey installed thereon; send, via the communications module and to the client device, a request for authentication; receive, via the communications module and from the client device, a signal that includes a unique confirmation message; and analyze the unique confirmation to confirm authentication.

In one or more embodiments, the request for authentication includes a unique cryptographic challenge.

In one or more embodiments, the unique confirmation message includes a response to the unique cryptographic challenge that is signed by the passkey.

In one or more embodiments, the passkey is stored on the client device in a secure element.

In one or more embodiments, the passkey is unlocked on the client device in response to completion of one or more biometric authentication methods.

In one or more embodiments, the request for authentication causes the client device to display a prompt requesting completion of the one or more biometric authentication methods.

In one or more embodiments, when determining that the client device has the passkey installed thereon, the instructions, when executed, further configure the at least one processor to perform a lookup using an identifier associated with the client device to determine that the client device has the passkey installed thereon.

In one or more embodiments, the voice call session includes an interactive voice response call.

In one or more embodiments, the instructions, when executed, further configure the at least one processor to responsive to confirming the authentication, route the voice call session to an agent terminal.

In one or more embodiments, the instructions, when executed, further configure the at least one processor to send, via the communications module and to the agent terminal, a signal that indicates confirmation of the authentication.

According to another aspect there is provided a computer-implemented method comprising initiating a voice call session with a client device; determining that the client device has a passkey installed thereon; sending, via a communications module and to the client device, a request for authentication; receiving, via the communications module and from the client device, a signal that includes a unique confirmation message; and analyzing the unique confirmation to confirm authentication.

In one or more embodiments, the request for authentication includes a unique cryptographic challenge.

In one or more embodiments, the unique confirmation message includes a response to the unique cryptographic challenge that is signed by the passkey.

In one or more embodiments, the passkey is stored on the client device in a secure element.

In one or more embodiments, the passkey is unlocked on the client device in response to completion of one or more biometric authentication methods.

In one or more embodiments, the request for authentication causes the client device to display a prompt requesting completion of the one or more biometric authentication methods.

In one or more embodiments, when determining that the client device has the passkey installed thereon, the method further comprises performing a lookup using an identifier associated with the client device to determine that the client device has the passkey installed thereon.

In one or more embodiments, the voice call session includes an interactive voice response call.

In one or more embodiments, the method further comprises responsive to confirming the authentication, routing the voice call session to an agent terminal.

According to another aspect there is provided a non-transitory computer readable storage medium comprising processor-executable instructions which, when executed, configure at least one processor to initiate a voice call session with a client device; determine that the client device has a passkey installed thereon; send, via a communications module and to the client device, a request for authentication; receive, via the communications module and from the client device, a signal that includes a unique confirmation message; and analyze the unique confirmation to confirm authentication.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

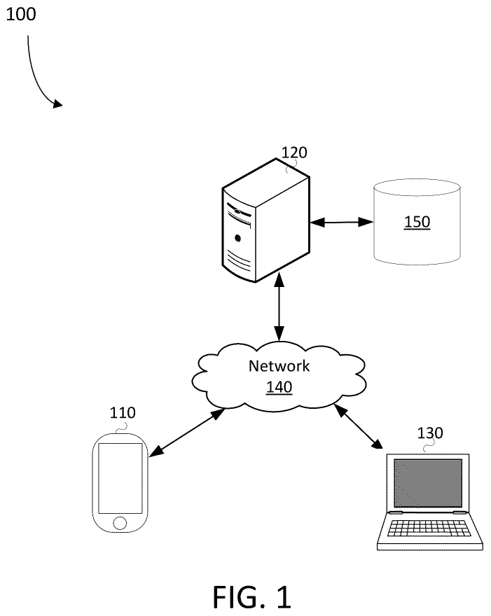

FIG. 1 is a schematic operation diagram illustrating an operating environment of an example embodiment. As shown, the system 100 includes a client device 110, a server computer system 120, and an agent terminal 130 coupled to one another through a network 140, which may include a public network such as the Internet and/or a private network. The client device 110, the server computer system 120, and the agent terminal 130 may be in geographically disparate locations. Put differently, the client device 110, the server computer system 120, and the agent terminal 130 may be located remote from one another.

The client device 110 may take a variety of forms including, for example, a mobile communication device such as a smartphone, a tablet computer, a wearable computer (such as a head-mounted display or smartwatch), a laptop or desktop computer, or a computing device of another type. The client device 110 may store software instructions that cause the client device 110 to establish communications with the server computer system 120 and/or the agent terminal 130.

The server computer system 120 may maintain a database 150 that includes various data records. For example, the server computer system 120 may be a financial institution server which may maintain customer bank accounts. In this example, a data record may, for example, reflect an amount of value stored in a particular account associated with a user. The amount of value may include a quantity of currency

The database 150 may include data records for a plurality of resource accounts and at least some of the data records may define a quantity of resources associated with a user or customer. For example, the user that is associated with the client device 110 may be associated with one or more resource accounts having one or more data records in the database 150. The data records may reflect a quantity of resources that are available to the user. Such resources may include owned resources and, in at least some embodiments, borrowed resources (e.g., resources available on credit). The quantity of resources that are available to or associated with a user may be reflected by a balance defined in an associated data record such as, for example, a bank balance. The resource accounts may include, for example, a chequing account, a savings account, a borrowing account such as for example a line of credit account, a credit card account, a loyalty point account, etc. As such, at least some of the data records may define a chequing account balance, a savings account balance, a line of credit account balance, a credit card account balance, a loyalty point account balance, etc.

The database 150 may additionally include data records for storing identity data of users or customers. The identity data may include, for example, a name, an email address, a social security number, an address, a phone number, etc. of the user. The identity data may include identity data previously-obtained to fulfill know-your-customer (KYC) requirements. The database may store additional information such as for example an indication that one or more client devices have passkeys installed thereon. The database may additional store one or more passkeys that may be used to authenticate a user or client device.

The agent terminal 130 may be a computer system that may communicate with the server computer system 120. The agent terminal 130 may interact with the server computer system 120 to perform tasks such as for example managing calls or processing requests. As will be described, the server computer system 120 may route voice call sessions to the agent terminal 130.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

As will be described in more detail, the server computer system 120 may field or otherwise handle voice call sessions and may perform operations to authenticate a user or client device prior to or during a voice call session. The voice call sessions may be initiated within a mobile application or may be initiated outside of the mobile application such as for example by using a built-in dialer or calling function resident on the client device 110. The server computer system 120 may route the voice call session to the agent terminal 130.

The client device 110 is adapted to present a graphical user interface that allows for communication with the server computer system 120 and/or the agent terminal 130. For example, the client device 110 may be adapted to receive, from the server computer system 120, a signal that causes the client device 110 to display a graphical user interface associated with a software or mobile application.

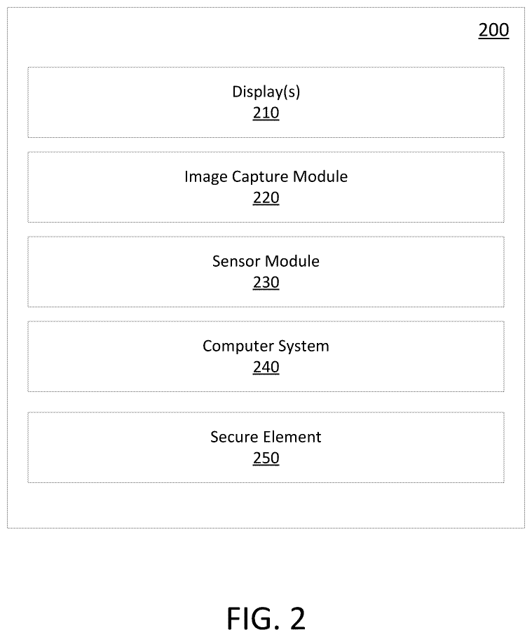

FIG. 2 is a simplified schematic diagram showing components of an exemplary computing device 200. The client device 110 and/or the agent terminal 130 may be of the same type as computing device 200. The computing device 200 may include modules including, as illustrated, for example, one or more displays 210, an image capture module 220, a sensor module 230, a computer system 240, and a Secure Element 250.

The one or more displays 210 are a display module. The one or more displays 210 are used to display screens of a graphical user interface that may be used, for example, to communicate with the server computer system 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

By way of further example, the sensor module 230 may include a biometric subsystem which generates biometric data associated with a user of the computing device 200. The biometric subsystem may obtain biometric data that may be used to identify or verify the user based on one or more physical characteristics. The biometric subsystem may include one or more of a fingerprint scanner, a facial recognition camera, an iris scanner, or any other type of biometric sensor configured to capture and process unique biological identifiers of the user.

The computer system 240 is in communication with the one or more displays 210, the image capture module 220, the sensor module 230, and/or the Secure Element 250. The computer system 240 may be or may include a processor which is coupled to the one or more displays 210, the image capture module 220, and/or the sensor module 230.

The Secure Element 250 is a dedicated, tamper-resistant part of the computing device 200 that is configured to store sensitive data securely. The Secure Element 250 may be isolated from other systems of the computing device 200 making it resistant to hacking or unauthorized users. The Secure Element may be configured to manage cryptographic keys used for authentication, payments, and other sensitive processes.

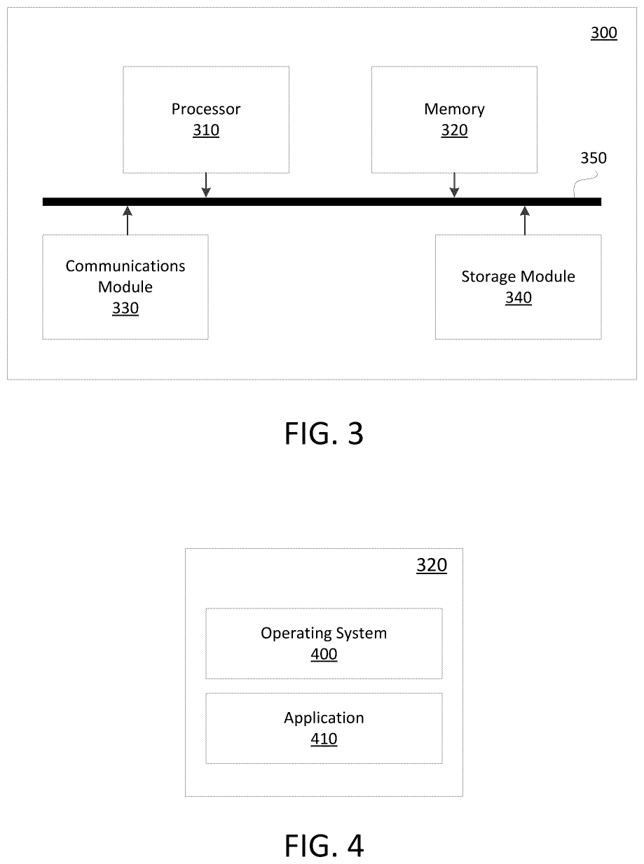

Referring now to FIG. 3, a high-level operation diagram of an example computer system 300 is shown. In some embodiments, the computer system 300 may be exemplary of the computer system 240 (FIG. 2) and/or the server computer system 120.

The example computer system 300 includes a variety of modules. For example, as illustrated, the example computer system 300 may include a processor 310, a memory 320, a communications module 330, and/or a storage module 340. As illustrated, the foregoing example modules of the example computer system 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer system 300.

The communications module 330 allows the example computer system 300 to communicate with other computer or computing devices and/or various communications networks. For example, the communications module 330 may allow the example computer system 300 to send or receive communications signals. Communications signals may be sent or received according to one or more protocols or according to one or more standards. For example, the communications module 330 may allow the example computer system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer system 300 to communicate using near-field communication (NFC), via Wi-Fi™, using Bluetooth™ or via some combination of one or more networks or protocols. In some embodiments, all or a portion of the communications module 330 may be integrated into a component of the example computer system 300. For example, the communications module may be integrated into a communications chipset. In some embodiments, the communications module 330 may be omitted such as, for example, if sending and receiving communications is not required in a particular application.

The storage module 340 allows the example computer system 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer system 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer system 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer system 300, in combination with the operating system 400, to operate as a device performing a particular function. For example, the application 410 may cooperate with the operating system 400 to adapt a suitable embodiment of the example computer system 300 to operate as the computer system 240 (FIG. 2) and/or the server computer system 120.

While a single application 410 is illustrated in FIG. 4, in operation the memory 320 may include more than one application 410 and different applications 410 may perform different operations. For example, in at least some embodiments in which the computer system 300 functions as the client device 110, the applications 410 may include a banking application. The banking application may be configured for secure communications with the server computer system 120 and may provide various banking functions such as, for example, the ability to display a quantum of value in one or more data records (e.g., display balances), configure or request that operations such as transfers of value (e.g., bill payments, email money transfers and other transfers) be performed, and other account management functions. For example, the banking application may be configured to authenticate the user to authorize a transfer request that defines a transfer amount and to define instructions based on session definition data.

By way of further example, in at least some embodiments in which the computer system 300 functions as the client device 110, the applications 410 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g., display balances), configure or request that operations such as transfers of value (e.g. bill payments and other transfers) be performed, and other account management functions. For example, the banking interface may be configured to authenticate the user to authorize a transfer request that defines a transfer amount and to define instructions based on session definition data.

The server computer system 120 may provide a mobile application that, when downloaded on the client device 110, may enable communication between the server computer system 120 and the client device 110. Specifically, when the mobile application is opened and/or used on the client device 110, the client device 110 may communicate with the server computer system 120 and this may be done to perform one or more actions.

In one or more embodiments, once the mobile application has been installed and opened on the client device 110, a configuration process may be performed that may require a user to authenticate using, for example, a username and password. The server computer system 120 may receive the username and password and may confirm that the username and password are correct. In response, the server computer system 120 may identify an account of the user.

Within the mobile application, the server computer system 120 may cause the client device 110 to present a selectable option to generate or otherwise create a passkey. The passkey may include a digital credential that may be used to authenticate the user and/or the client device 110 without a username or password, a process that may be referred to as passwordless authentication. For example, when the user wants to sign into the mobile application, the user may authenticate using the passkey and one or more biometric sensors of the client device 110.

To create the passkey, the user may cause the client device 110 to navigate to a settings or configuration page within the mobile application. For example, within the mobile application, the user may select a selectable option to configure security or authentication settings for the mobile application. In response, the client device 110 may present a list of security or authentication settings and the list may include a selectable option to set up a passkey. The user may select the selectable option to set up the passkey and, in response, operations may be performed to create the passkey.

In one or more embodiments, the client device 110 may create the passkey. For example, the operating system of the client device 110 may include a service such as for example Apple™ Passkey, Google™ Passkey, Microsoft™ Passkey, etc. that may be engaged to create or otherwise generate the passkey.

To create the passkey, the client device 110 may require the user to authenticate using one or more biometric sensors such as for example a fingerprint scanner, a facial recognition camera, an iris scanner, or any other type of biometric sensor configured to capture and process unique biological identifiers of the user. The client device 110 may utilize built-in authentication methods such as for example Face ID, Touch ID, etc. to authenticate the user.

Once authenticated, the client device 110 may create the passkey. Specifically, the client device 110 may generate a keypair that includes a private key and a public key. The private key may be stored on a Secure Element (SE) of the client device 110. As described above, the Secure Element of the client device 110 may ensure that the private key is not extracted or accessed by malware or the main operating system itself.

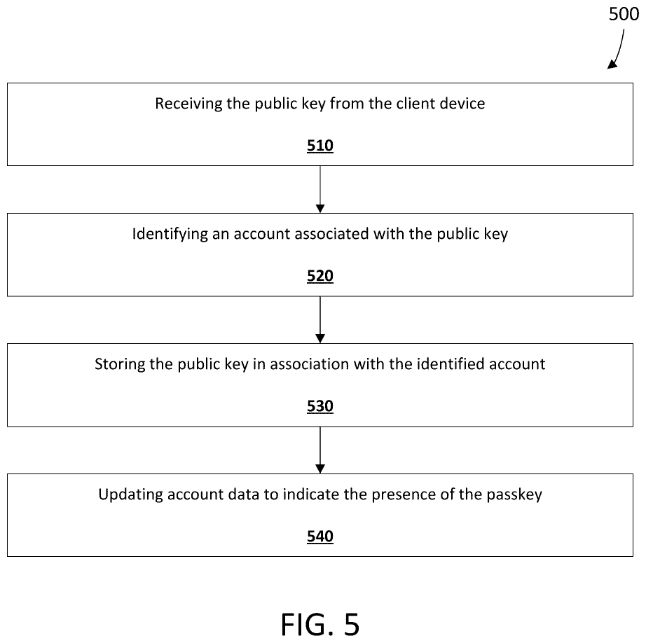

The client device 110 may send the public key to the server computer system 120 for storage and in response the server computer system 120 may perform operations to store the public key. Reference is made to FIG. 5, which illustrates, in flowchart form, a method 500 for storing a public key. The method 500 may be implemented by a computing device having suitable processor-executable instructions for causing the computing device to carry out the described operations. The method 500 may be implemented, in whole or in part, by the server computer system 120. The server computer system 120 may off-load some operations of the method 500 to the client device 110 (FIG. 1).

The method 500 includes receiving the public key from the client device (step 510).

The server computer system 120 receives the public key from the client device. The public key may be sent from the client device 110 within the mobile application associated with the server computer system 120.

The method 500 includes identifying an account associated with the public key (step 520).

The server computer system 120 identifies an account associated with the public key. The account may include the account of the user within the mobile application executing on the client device 110 and as such the server computer system 120 may identify the account based on the authentication.

The method 500 includes storing the public key in association with the identified account (step 530).

The public key is stored in a database in association with the identified account. For example, the server computer system 120 may store the public key in the database as part of the account data or may store the public key in the database in association with the account data.

The method 500 includes updating account data to indicate the presence of the passkey (step 540).

In one or more embodiments, in addition to storing the public key as part of the account data or in association with the account data, the server computer system 120 may update the account data to indicate the presence of the passkey. For example, the account data may include a binary field that may be set to a value of one (1) indicating the presence of the passkey. It will be appreciated that the binary field may be set to a value of zero (0) indicating the absence of the passkey or indicating that the passkey has not been created for the account. The default value of the binary field is zero (0). As will be described, the binary field may serve as an indication as to whether or not a passkey is available on the client device 110.

Once setup, the passkey may be used to log into the mobile application on the client device 110. For example, the mobile application may be opened on the client device 110 and the user may be required to login. The client device 110 may prompt the user to authenticate using one or more biometric sensors such as for example a fingerprint scanner, a facial recognition camera, an iris scanner, or any other type of biometric sensor configured to capture and process unique biological identifiers of the user. The client device 110 may utilize built-in authentication methods such as for example Face ID, Touch ID, etc. to authenticate the user.

Once biometric authentication has been completed, access to the private key may be unlocked. Specifically, the client device 110 may access the private key stored in the Secure Element. The server computer system 120 may send a challenge to the mobile application on the client device 110. The client device 110 uses the private key to sign the challenge and the signed challenge is sent back to the server computer system 120 for verification. The server computer system 120 verifies the signed challenge using the public key stored in the database. If the verification succeeds, the server computer system 120 grants access.

In manners described herein, passwordless authentication may be performed using biometrics and the passkey to grant the user access to the mobile application.

As mentioned, the server computer system 120 may field or otherwise handle voice call sessions and may perform operations to authenticate a user or client device prior to or during the voice call session. The voice call sessions may be initiated within a mobile application or may be initiated outside of the mobile application such as for example by using a built-in dialer or calling function resident on the client device 110.

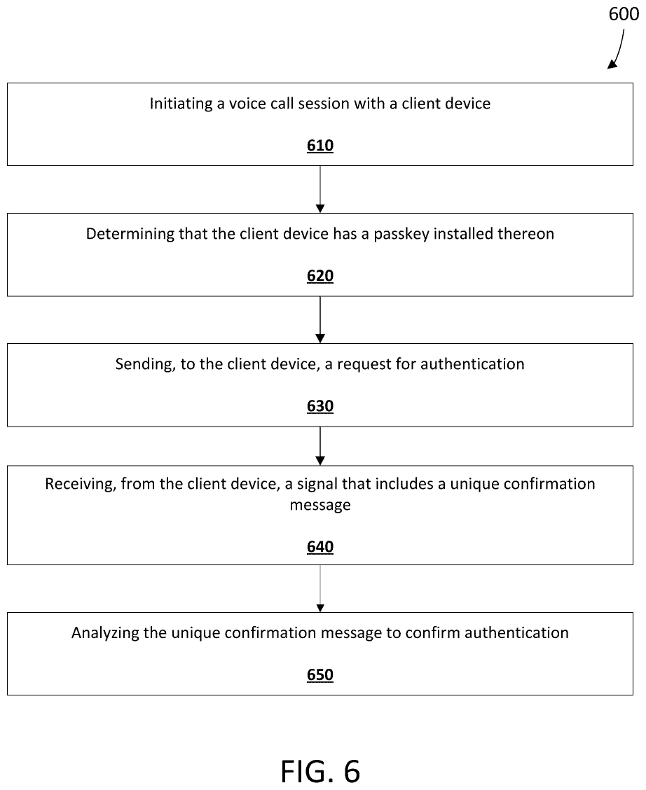

Reference is made to FIG. 6, which illustrates, in flowchart form, a method 600 for digital authentication during a voice call. The method 600 may be implemented by a computing device having suitable processor-executable instructions for causing the computing device to carry out the described operations. The method 600 may be implemented, in whole or in part, by the server computer system 120. The server computer system 120 may off-load some operations of the method 600 to the client device 110 and/or the agent terminal 130 (FIG. 1).

The method 600 includes initiating a voice call session with a client device (step 610).

In one or more embodiments, the client device may initiate a call by dialing a telephone number associated with a call center hosted or maintained by the server computer system 120.

The client device may initiate the voice call session within the mobile application. For example, an application programming interface (API) such as a telephony API may be engaged to initiate the call on the client device within the mobile application where the API may launch a built-in dialer or calling function resident on the client device 110 to initiate the call. As another example, the voice call session may be initiated using Voice over IP (VoIP) technologies.

The client device may initiate the voice call session outside of the mobile application. For example, the built-in dialer or calling function resident on the client device 110 may be used to initiate the call.

As will be appreciated, in one or more embodiments the call may be routed through a telephony network to establish a connection.

In one or more embodiments, the call may be directed to the call centers routing system that may automatically assign incoming calls to available agents based on predefined rules. The agent may answer the call to initiate a voice call session with the client device.

In one or more embodiments, the call center may include an Interactive Voice Response (IVR) system that may use pre-recorded messages and touch-tone keypad or voice input to guide the caller through a series of options. In these embodiments, upon receiving the call to initiate the voice call session, the server computer system 120 may identify the incoming number and may establish or otherwise initiate a voice call session with the client device.

The server computer system 120 may identify the incoming number when the call to initiate the voice call session is received at the routing system or as soon as the incoming call is registered with the IVR. Put another way, the incoming number may be identified by the server computer system 120 at the call initiation phase prior to the call being answered or just as the voice call session is being connected to an IVR or agent. The incoming number may be used as an identifier associated with the client device 110. The incoming number may include a telephone number associated with the client device 110.

The method 600 includes determining that the client device has a passkey installed thereon (step 620).

The server computer system 120 may perform operations to determine that the client device has a passkey installed thereon and this may be done prior to the call being answered or just as the call is being connected to an IVR or agent. In one or more embodiments, the server computer system 120 may perform the operations to determine that the client device has the passkey installed therein in response to identifying the incoming number.

In one or more embodiments, the server computer system 120 may determine that the client device has the passkey installed thereon by consulting the database.

In one or more embodiments, the server computer system 120 may perform a lookup using an identifier associated with the client device to determine that the client device has the passkey installed thereon. The identifier may include the telephone number associated with the client device 110 that initiated the voice call session.

In these embodiments, the server computer system 120 may perform the lookup using the telephone number associated with the client device 110 and this may identify an account. Put another way, the server computer system 120 may search through the database using the telephone number to identify an account that includes the telephone number in the account data.

Once the account has been identified, the server computer system 120 may analyze the account data to determine whether or not the client device 110 has a passkey installed thereon. For example, the server computer system 120 may identify that a public key has been stored in association with the account and as such may identify that the client device 110 has a passkey installed thereon. As another example, the server computer system 120 may analyze the account data to identify the value of the binary field indicating the presence of the passkey. When the value of the binary field is one (1), the server computer system 120 may determine that the client device 110 has a passkey installed thereon.

The method 600 includes sending, to the client device, a request for authentication (step 630).

Responsive to determining that the client device 110 has a passkey installed thereon, the server computer system 120 may send a request for authentication. The request for authentication may include a request for digital authentication that may utilize the passkey installed on the client device 110.

In one or more embodiments, the request for authentication may cause the client device 110 to display a prompt requesting completion of one or more biometric authentication methods. For example, the server computer system 120 may send a signal causing the client device 110 to display a notification requesting authentication. The notification may be displayed in a notification center associated with an operating system of the client device 110 or may be displayed in the mobile application associated with the server computer system 120. The notification may include a selectable link that, when selected, initiates authentication. For example, the selectable link, when selected, may direct the client device 110 to open the mobile application on the client device 110 to authenticate the user.

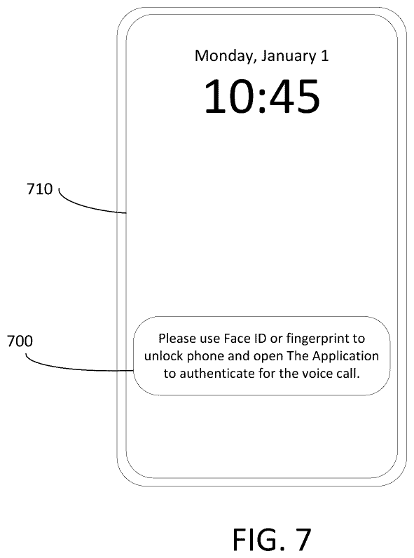

An example notification 700 is shown in FIG. 7. As can be seen, the notification 700 is displayed on a lock screen 710 of a client device. The notification 700 asks the user to complete a biometric authentication method.

In one or more embodiments, the notification may be sent as a short messaging service (SMS) message to the telephone number of the client device 110. The SMS message may include the prompt requesting authentication and may include a selectable link that, when selected, initiates authentication. For example, the selectable link, when selected, may direct the client device 110 to open the mobile application on the client device 110 to authenticate the user.

In one or more embodiments, the notification may include an audio recording that may be output during the IVR. For example, the IVR may prompt the caller by outputting an audio message such as “Please open the mobile application on your mobile device to authenticate.” As another example, the IVR may prompt the caller by outputting an audio message such as “We just sent you a link to authenticate—please check your messages.”

In one or more embodiments, the request for authentication may include a unique cryptographic challenge. For example, the server computer system 120 may send a challenge to the mobile application on the client device 110.

During authentication, the client device 110 may prompt the user to authenticate using one or more biometric sensors such as for example a fingerprint scanner, a facial recognition camera, an iris scanner, or any other type of biometric sensor configured to capture and process unique biological identifiers of the user. The client device 110 may utilize built-in authentication methods such as for example Face ID, Touch ID, etc. to authenticate the user.

Responsive to successful biometric authentication, the client device 110 may perform operations to generate a reply to the unique cryptographic challenge that includes a unique confirmation message. For example, in response to completion of one or more biometric authentication methods, the passkey, in particular the private key, may be unlocked on the client device 110. The client device 110 accesses the private key stored in the Secure Element and uses the private key to sign the challenge.

The client device 110 sends the unique confirmation message to the server computer system 120.

The method 600 includes receiving, from the client device, a signal that includes a unique confirmation message (step 640).

The server computer system 120 receives, from the client device 110, the signal that includes the unique confirmation message. As mentioned, the unique confirmation message may include a response to the unique cryptographic challenge that is signed by the passkey, in particular the private key, stored on the client device 110.

The method 600 includes analyzing the unique confirmation to confirm authentication (step 650).

The server computer system 120 analyzes the unique confirmation message to confirm authentication. For example, the server computer system 120 may verify the signed challenge using the public key stored in the database in association with the account. If the verification succeeds, the server computer system 120 confirms authentication.

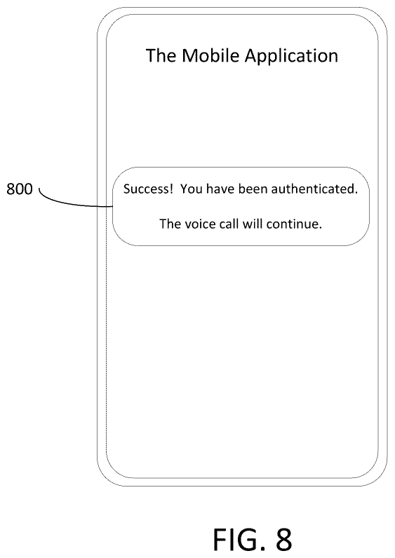

The server computer system 120 may send a signal to the client device 110 indicating successful authentication and in response the client device 110 may display a notification indicating successful authentication. An example notification 800 is shown in FIG. 8. The example notification 800 may be displayed after the notification 700 shown in FIG. 7. For example, the user may have performed a tap gesture on the display screen of the client device at a location that corresponds to the location of the notification 700. In response, the user may complete the requested biometric authentication methods such as for example using Face ID. In response, the server computer system 120 may complete authentication using the passkey (as described herein). While authentication using the passkey is being completed, the client device 110 may be directed to open the mobile application and once opened, the notification 800 may be displayed within the mobile application indicating successful authentication.

Responsive to confirming authentication, the server computer system 120 may perform one or more operations. For example, responsive to confirming authentication, the server computer system 120 may route the voice call session to an agent terminal. The server computer system 120 may additionally send a signal to the agent terminal that indicates the confirmation of the authentication. For example, the agent terminal may display the indication on a display screen thereof and this may serve as an indication to the operator of the agent terminal that the client device 110 and/or user have been authenticated. As such, the operator is no longer required to ask the user (or customer) proof-of-identity questions to verify their identity.

It will be appreciated that authentication may not be confirmed and as such the server computer system 120 may not authenticate the client device 110 and/or user using digital authentication. In this scenario, traditional authentication methods such as asking proof-of-identity questions may be used.

In manners described herein, the server computer system 120 utilizes the passkey to authenticate the user during a voice call session. As such, once the client device 110 has authenticated, the user or customer is no longer required to authenticate with the agent by answering proof-of-identity questions. Put another way, through use of the passkey, the risk of fraud is reduced as knowledge or guessable personal information is not relied upon for authentication. The passkeys described herein rely on cryptographic techniques that ensure both the user's identity and the client device are securely paired. The passkeys generated by the client device are unique to the user and the mobile application making it difficult for attackers to replicate or intercept the authentication process. By eliminating the need for shared secrets, such as security questions, the system described herein minimizes the vulnerabilities associated with authentication and effectively prevents unauthorized access.

Further, in manners described herein, the server computer system 120 uses an identifier, such as a phone number, associated with the client device to readily determine whether or not the client device has a passkey installed thereon that may be used to authenticate the user. As such, the server computer system 120 may perform a lookup in a database to retrieve a value of a binary field and/or to determine the presence of a public key to determine whether or not digital authentication may be used. The use of digital authentication reduces the risk of fraud and eliminates the requirement of the agent asking proof-of-identity questions. Further, since the server computer system 120 only attempts digital authentication when it has been determined that a passkey is available, the server computer system 120 does not unnecessarily waste or consume computing resources attempting to digitally authenticate a client device or user when a passkey is not available.

The use of passkeys described herein streamlines the authentication process. For example, traditional authentication methods often involve server-side storage of sensitive data (e.g. passwords or answers to security questions) and complex server-side checks which require significant computational power. In contrast, the use of passkeys described herein only stores public passkeys on the server computer system 120 (or database). The private keys never leave the client device 110. This reduces the need for intensive server-side processing and decreases the overall memory storage requirements. Further, the use of passkey verification is computationally efficient enabling secure authentication with lower computer resource consumption.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A computer system comprising:
at least one processor;
a communications module coupled to the at least one processor; and
a memory coupled to the at least one processor, the memory storing instructions that, when executed, configure the at least one processor to:
initiate a voice call session with a client device;
determine that the client device has a passkey installed thereon;
send, via the communications module and to the client device, a request for authentication;
receive, via the communications module and from the client device, a signal that includes a unique confirmation message; and
analyze the unique confirmation to confirm authentication.

2. The computer system of claim 1, wherein the request for authentication includes a unique cryptographic challenge.

3. The computer system of claim 2, wherein the unique confirmation message includes a response to the unique cryptographic challenge that is signed by the passkey.

4. The computer system of claim 1, wherein the passkey is stored on the client device in a secure element.

5. The computer system of claim 4, wherein the passkey is unlocked on the client device in response to completion of one or more biometric authentication methods.

6. The computer system of claim 5, wherein the request for authentication causes the client device to display a prompt requesting completion of the one or more biometric authentication methods.

7. The computer system of claim 1, wherein when determining that the client device has the passkey installed thereon, the instructions, when executed, further configure the at least one processor to:
perform a lookup using an identifier associated with the client device to determine that the client device has the passkey installed thereon.

8. The computer system of claim 1, wherein the voice call session includes an interactive voice response call.

9. The computer system of claim 8, wherein the instructions, when executed, further configure the at least one processor to:
responsive to confirming the authentication, route the voice call session to an agent terminal.

10. The computer system of claim 9, wherein the instructions, when executed, further configure the at least one processor to:
send, via the communications module and to the agent terminal, a signal that indicates confirmation of the authentication.

11. A computer-implemented method comprising:
initiating a voice call session with a client device;
determining that the client device has a passkey installed thereon;
sending, via a communications module and to the client device, a request for authentication;
receiving, via the communications module and from the client device, a signal that includes a unique confirmation message; and
analyzing the unique confirmation to confirm authentication.

12. The computer-implemented method of claim 11, wherein the request for authentication includes a unique cryptographic challenge.

13. The computer-implemented method of claim 12, wherein the unique confirmation message includes a response to the unique cryptographic challenge that is signed by the passkey.

14. The computer-implemented method of claim 11, wherein the passkey is stored on the client device in a secure element.

15. The computer-implemented method of claim 14, wherein the passkey is unlocked on the client device in response to completion of one or more biometric authentication methods.

16. The computer-implemented method of claim 15, wherein the request for authentication causes the client device to display a prompt requesting completion of the one or more biometric authentication methods.

17. The computer-implemented method of claim 11, wherein when determining that the client device has the passkey installed thereon, the method further comprises:
performing a lookup using an identifier associated with the client device to determine that the client device has the passkey installed thereon.

18. (canceled)

19. The computer-implemented method of claim 18, wherein the method further comprises:
responsive to confirming the authentication, routing the voice call session to an agent terminal.

20. A non-transitory computer readable storage medium comprising processor-executable instructions which, when executed, configure at least one processor to:
initiate a voice call session with a client device;
determine that the client device has a passkey installed thereon;
send, via a communications module and to the client device, a request for authentication;
receive, via the communications module and from the client device, a signal that includes a unique confirmation message; and
analyze the unique confirmation to confirm authentication.

21. The computer system of claim 6, wherein the one or more biometric authentication methods include facial identification by performing image recognition on image data captured by a facial recognition camera.
